(19) United States
(12) Patent Application Publication
(10) Pub. No.: US 2026/0154578 A1
(43) Pub. Date: Jun. 4, 2026

(54) REAL-TIME HALLUCINATION DETECTION AND CORRECTION FOR LARGE LANGUAGE MODEL(S)

(71) Applicant: GOOGLE LLC, Mountain View, CA (US)

(72) Inventors: Sasha Zykova, Mountain View, CA (US); Tej Toor, Brooklyn, NY (US); Jan van de Kerkhof, Mountain View, CA (US); Stefano Spigler, Mountain View, CA (US); Marcin Pikus, Mountain View, CA (US); Eyal Ben-David, Mountain View, CA (US); Eran Ofek, Rehovot (IL); Alex Fabrikant, Mountain View, CA (US); Krunoslav Zaher, Mountain View, CA (US); Mathias Carlen, Zurich (CH); Jeremy Cole, Mountain View, CA (US); Kelvin Gu, Redwood City, CA (US); Teghan Tracy, Boulder, CO (US)

(21) Appl. No.: 19/405,146

(22) Filed: Dec. 1, 2025

Related U.S. Application Data
(60) Provisional application No. 63/726,938, filed on Dec. 2, 2024.

(51) Int. Cl. G06N 5/04; G06F 16/3329; G06F 16/34; G06F 18/27; G06F 40/289; G06N 3/0475; G06N 20/00

(52) U.S. Cl. CPC G06N 5/04; G06F 16/3329; G06F 16/34; G06F 18/27; G06F 40/289; G06N 3/0475; G06N 20/00

(57) ABSTRACT

Implementations are described herein for automatically identifying and correcting potentially false information in generative model output by performing entailment evaluation of generative model output. In various implementations, data indicative of a query may be processed to generate generative model output. Textual fragments may be extracted from the generative model output, and a subset of the textual fragments may be classified as being suitable for textual entailment analysis. Textual entailment analysis may be performed on each textual fragment of the subset, including formulating a search query based on the textual fragment, retrieving document(s) responsive to the search query, and processing the textual fragment and the document(s) using entailment machine learning model(s) to generate prediction(s) of whether the at least one document corroborates or contradicts the textual fragment. Based on the textual entailment analysis, at least a portion of the generative model output which is to be rewritten is determined.

### BACKGROUND

Generative models are types of machine learning models that generate sequences of output data based on sequences of input data. Large language models (LLMs) are one type of generative model that can perform various natural language processing (NLP) tasks, such as language generation, machine translation, and question-answering, to name a few. LLMs are typically trained on enormous amounts of diverse data including data from, but not limited to, webpages, electronic books, software code, electronic news articles, and machine translation data. Accordingly, these LLMs leverage the underlying data on which they were trained in performing these various NLP tasks. For instance, in performing a language generation task, these LLMs can process a natural language (NL) based input that is received from a client device, and generate a NL based output that is responsive to the NL based input and that is to be rendered at the client device.

One challenge of LLMs and generative models more generally is that they occasionally produce false information, sometimes referred to as ‘hallucinations’. False information erodes the trust of users and leads to decreased use of and reliance upon generative models. However, LLM-generated hallucinations are not always easily identifiable, and can be time consuming to manually validate and/or remove.

### SUMMARY

Implementations are described herein for automatically identifying and automatically correcting potentially false information and/or hallucinations contained in documents and/or textual content, including but not limited to generative model output. More particularly, but not exclusively, techniques are described herein for performing entailment evaluation of documents and/or generative model output and for automatically using this entailment evaluation to rewrite and/or correct aspects of these documents and/or generative model output. In this manner, the techniques described herein can ensure that a client device rendering these documents and/or generative model output as output to a user can refrain from rendering potentially false information and/or hallucinations, and/or can quickly and efficiently remove any potentially false information and/or hallucinations that are being rendered from display.

In various implementations, a query associated with a client device operated by a user may be received. For example, the query may be captured as a spoken utterance at the client device and transcribed into a textual query. As another example, the user may type the query as a textual query at the client device. Data indicative of the query may be processed, using a generative model, to generate generative model output. Generative model output can take various forms, and can represent or directly convey words, phrases, embeddings, images, videos, audio, etc. Specifically, the generative model may be trained/fine-tuned and/or prompted such that, by processing the data indicative of the query, it can provide responsive content (e.g., the generative model output) which is responsive to that query. As a specific example, a query may be “How many moons does the planet Mars have?”, and the corresponding generative model output may be “Hello! Mars has two moons—they are called Ares and Deimos.”.

The generative model output may be generated in a ‘real-time’ manner, e.g., the generative model output may be generated as a series of segments (e.g., words, phrases, fragments, statements, facts, clauses, images, videos, audio, etc.), one after another. By outputting these segments (e.g., causing them to be rendered at the client device) one after another (e.g., responsive to them being generated and/or received from a system which implements the generative model), the generative model output can be rendered to the user in a real-time manner. This may allow output to be rendered to the user quickly and seamlessly.

A plurality of textual fragments may be extracted from the generative model output. These textual fragments may be any meaningful fragments of text (e.g., statements, facts, clauses etc.). It will be appreciated that whilst, in some scenarios, a textual fragment may correspond to a complete sentence, in many examples, complete sentences will contain multiple textual fragments. Returning to the specific example above, the following textual fragments could be extracted from the generative model output: (i) “Hello!”; (ii) “Mars has two moons”; and (iii) “they are called Ares and Deimos”.

A subset of the textual fragments may be classified as suitable for textual entailment analysis. This subset may include at least a first textual fragment. Various criteria and/or techniques can be used to determine which textual fragment(s) are suitable for textual entailment analysis, but it will be appreciated that these textual entailment analysis can be applied to textual fragment(s) which are to at least some extent verifiable (e.g., can be confirmed as true or false based on a fact-based analysis). Returning to the specific example above, the fragment “Hello!” may not be suitable for textual entailment analysis because it does not contain factual material suitable for verification. By contrast, the fragments “Mars has two moons” and “they are called Ares and Deimos” may be suitable for textual entailment analysis because they each contain at least one fact suitable for verification. One possible technique for classifying textual fragments is to use a regression machine learning model that is trained to predict textual entailment analysis suitability scores for textual fragments.

Textual entailment analysis may be performed individually on each textual fragment of the subset. The textual entailment analysis, for each textual fragment of the subset, may include formulating a search query based on the textual fragment; retrieving at least one document that is responsive to that search query; and processing the textual fragment and the at least one document using one or more entailment machine learning models to generate one or more predictions of whether the at least one document corroborates or contradicts the textual fragment. Where the subset of textual fragments contains multiple textual fragments, the textual entailment analysis can be performed on these fragments in parallel (e.g., simultaneously), in order to increase the speed at which the textual fragments are processed.

Returning to the specific example above, a search query for the textual fragment “Mars has two moons” may be “Does Mars have two moons?”, and a search query for the textual fragment “they are called Ares and Deimos” may be “What are the names of Mars' moons?”. Document(s) responsive to these search queries (e.g., document(s) containing fact-based evidence which can be used to answer these search queries) can be retrieved by any suitable means, such as using search system(s) (e.g., internet-based search system(s)), knowledge graph(s), database(s), etc.

Each textual fragment and its corresponding retrieved document(s) may be processed by entailment machine learning model(s) (which may include, for example, a corroboration machine learning model trained to generate first output indicative of whether a document corroborates a textual fragment and/or a contradiction machine learning model trained to generate second output indicative of whether a document contradicts a textual fragment) to determine whether the textual fragment successfully entails the document(s) (i.e., they are factually verified) or whether the textual fragment does not successfully entail the document(s) (i.e., they are not factually verified). For example, this may involve comparing the first output from the corroboration machine learning model to the second output from the contradiction machine learning model. Returning to the specific example above, a prediction generated for the textual fragment “Mars has two moons” may be a prediction that this textual fragment is corroborated by the document(s) (e.g., because the document(s) may correctly identify that Mars does have two moons), and a prediction generated for the textual fragment “they are called Ares and Deimos” may be a prediction that this textual fragment is contradicted by the document(s) (e.g., because the document(s) may correctly identify that Mars' two moons are actually called Phobos and Deimos, not Ares and Deimos). Specifically, the prediction relating to the textual fragment “they are called Ares and Deimos” may satisfy a threshold (e.g., a threshold likelihood) that indicates that the document(s) contradict the textual fragment.

Based on the textual entailment analysis of the first textual fragment, it may be determined that at least a portion of the generative model output comprising the first textual fragment is to be rewritten. In the specific example described above, the first textual fragment may correspond to the textual fragment “they are called Ares and Deimos” (i.e., a textual fragment which needs to be written because it is contradicted by the retrieved document(s)), whilst the textual fragment “Mars has two moons” may be a different, second, textual fragment (i.e., a textual fragment which does not need to be rewritten because it is corroborated by the retrieved document(s)).

Responsive to the determination that at least the portion of the generative model output including the first textual fragment should to be rewritten, revised generative model output (i.e., generative model output which rewrites the portion including the first textual fragment) can be generated. This revised generative model output can be generated based on processing, using the generative model data indicative of the query (e.g., data indicating the original query), data indicative of a portion of the generative model output currently rendered for display at the client device (e.g., data indicating what aspects of the previously generated generative model output have already been rendered as output to the user), and data indicative of the first textual fragment (e.g., data indicating the aspect of the generative model output which is contradicted, and should thus be rewritten). The generative model may further process the at least one document retrieved responsive to the search query formulated for the first textual fragment (e.g., data indicating why the first textual fragment of the generative model output is contradicted) in order to generate the revised generative model output.

If the portion of the generative model output including the first textual fragment has already been rendered as output (e.g., at the client device), the client device can be instructed to remove at least the portion of the generative model output including the first textual fragment from display. For example, this may involve ‘rolling back’ just the portion of the generative model output including the first textual fragment, or may involve, e.g., rolling back a whole sentence including the portion of the generative model output including the first textual fragment. Instead, the client device can be instructed to render the revied generative model output. In order to identify and explain this real-time rolling back to the user, in some scenarios, a UI affordance can be rendered by the client device which explains that the portion of the generative model output including the first textual fragment has been removed from display and rewritten. Optionally, this UI affordance can further provide the document(s) (or extract(s) from the document(s)) which contradict the first textual fragment (i.e., providing specific evidence as to why the portion of the generative model output including the first textual fragment was removed from display and rewritten).

If the portion of the generative model output including the first textual fragment has not yet been rendered as output (e.g., at the client device), the client device can be instructed to refrain from displaying at least the portion of the generative model output including the first textual fragment. Instead, the client device can be instructed to render the revied generative model output.

Using the techniques described herein may provide a variety of technical advantages. For example, the techniques described herein can automatically identify and automatically correct potential false information and/or hallucinations contained in documents and/or textual content. In particular, existing techniques for correcting this kind of false information can be computationally expensive (e.g., with respect to computational processing and/or network resources). For example, existing techniques for correcting false information can involve users providing explicit input to identify passages of output which should be re-examined and/or checked, which may use additional network resources between a client device and a server implementing the generative model, and which may be slower than the automatic correction techniques described herein.

Additionally, the automatic correction techniques described herein (e.g., automatically generating revised generative model output) may be computationally less expensive for the system that implements the generative model. Specifically, the techniques described herein involve a real-time, ‘re-prompting’-based approach to correction which can allow the generative model to reuse processing and/or context (e.g., processing and/or context related to generating the original generative model output) when generating the revised generative model output. For example, aspects of the generative model output which have already been rendered to a user (and which may already be corroborated) can be used to bias (e.g., create a basis for) the form which the revised generative model output should take (e.g., in that the revised generative model output can build from these corroborated aspects of the generative model output). Existing techniques, for example, may require performing separate correction step(s) after the generation of model output has finished, which can prevent the above-described computational savings (e.g., with respect to processing and/or context) from being made.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 schematically depicts an example of how various components described herein may cooperate to perform selected aspects of the present disclosure.

FIG. 3A and FIG. 3B schematically depict an example of a graphical user interface (GUI) being used in accordance with various implementations described herein.

FIG. 4 depicts an example of logic that may be implemented to determine whether a portion of the generative model output is to be rewritten, in accordance with various implementations.

FIG. 5 depicts a flowchart illustrating an example method of practicing selected aspects of the present disclosure.

FIG. 6 depicts an example architecture of a computing device, in accordance with various implementations.

### DETAILED DESCRIPTION OF THE DRAWINGS

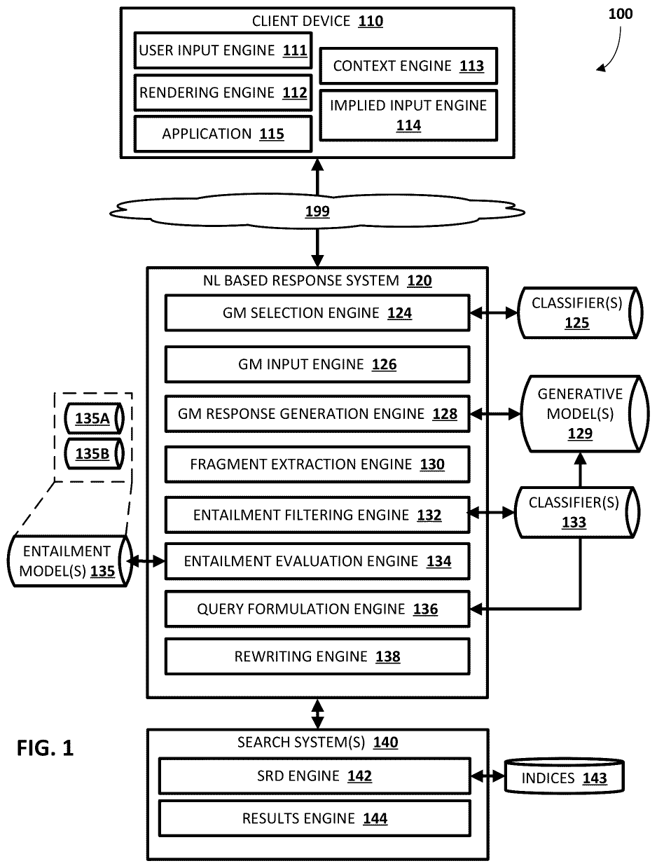

Turning now to FIG. 1, a block diagram of an example environment 100 that demonstrates various aspects of the present disclosure, and in which implementations disclosed herein can be implemented is depicted. The example environment 100 includes a client device 110, a natural language (NL) based response system 120, and search system(s) 140. Although illustrated separately, in some implementations all or aspects of NL based response system 120 and all or aspects of search system(s) 140 can be implemented as part of a cohesive system.

In some implementations, all or aspects of the NL based response system 120 can be implemented locally at the client device 110. In additional or alternative implementations, all or aspects of the NL based response system 120 can be implemented remotely from the client device 110 as depicted in FIG. 1 (e.g., at remote server(s)). In those implementations, the client device 110 and the NL based response system 120 can be communicatively coupled with each other via one or more networks 199, such as one or more wired or wireless local area networks (“LANs,” including Wi-Fi LANs, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more applications, such as application 115, via which queries can be submitted and/or NL based summaries and/or other response(s) to the query can be rendered (e.g., audibly and/or visually). The application 115 can be an application that is separate from an operating system of the client device 110 (e.g., one installed “on top” of the operating system)—or can alternatively be implemented directly by the operating system of the client device 110. For example, the application 115 can be a web browser installed on top of the operating system, or can be an application that is integrated as part of the operating system functionality. The application 115 can interact with the NL based response system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the client device 110. Some instances of a query described herein can be a query that is formulated based on user input provided by a user of the client device 110 and detected via user input engine 111. For example, the query can be a typed query that is typed via a physical or virtual keyboard, a suggested query that is selected via a touch screen or a mouse, a spoken voice query that is detected via microphone(s) of the client device, or an image query that is based on an image captured by a vision component of the client device.

In various implementations, the client device 110 can include a rendering engine 112 that is configured to provide content (e.g., an NL based summary, creative generative model output, chat output, etc.) for audible and/or visual presentation to a user of the client device 110 using one or more user interface output devices. For example, the client device 110 can be equipped with one or more speakers that enable content to be provided for audible presentation to the user via the client device 110. Additionally, or alternatively, the client device 110 can be equipped with a display or projector that enables content to be provided for visual presentation to the user via the client device 110.

In various implementations, the client device 110 can include a context engine 113 that is configured to determine a context (e.g., current or recent context) of the client device 110 and/or of a user of the client device 110. In a multi-turn session between the user and an automated assistant (alternatively, “virtual assistant”, “chatbot”, etc.), the context of the client device and/or user may be maintained over multiple turns as a “user state.”

In some implementations, the context engine 113 can determine a context and/or update the user's state utilizing current or recent interaction(s) via the client device 110, a location of the client device 110, profile data of a profile of a user of the client device 110 (e.g., an active user when multiple profiles are associated with the client device 110), and/or other data accessible to the context engine 113. For example, the context engine 113 can determine a current context based on a one or more recent queries of the search session, profile data, and/or a current location of the client device 110. For instance, the context engine 113 can determine a current context of “looking for a healthy lunch restaurant in Louisville, Kentucky” based on a recently issued query, profile data, and a location of the client device 110.

As another example, the context engine 113 can determine a current context based on which application is active in the foreground of the client device 110, a current or recent state of the active application, and/or content currently or recently rendered by the active application. A context determined by the context engine 113 can be utilized, for example, in supplementing or rewriting a query that is formulated based on user input, in generating an implied query (e.g., a query formulated independent of user input), and/or in determining to submit an implied query and/or to render result(s) (e.g., an NL based summary) for an implied query. And the user's context across multiple turns of a search session can be used as the aforementioned user state to enrich output rendered, e.g., by a search chatbot companion, at each turn of the multi-turn human-to-computer dialog session.

In various implementations, the client device 110 can include an implied input engine 114 that is configured to: generate an implied query independent of any user input directed to formulating the implied query; to submit an implied query, optionally independent of any user input that requests submission of the implied query; and/or to cause rendering of result(s) for an implied query, optionally independent of any user input that requests rendering of the result(s)). For example, the implied input engine 114 can use current context, from current context engine 113, in generating an implied query, determining to submit the implied query, and/or in determining to cause rendering of result(s) for the implied query. For instance, the implied input engine 114 can automatically generate and automatically submit an implied query based on the current context. Further, the implied input engine 114 can automatically push result(s) to the implied query to cause them to be automatically rendered or can automatically push a notification of the result(s), such as a selectable notification that, when selected, causes rendering of the result(s). As another example, the implied input engine 114 can generate an implied query based on profile data (e.g., an implied query related to an interest of a user), submit the query at regular or non-regular intervals, and cause corresponding result(s) for the submission(s) to be automatically provided (or a notification thereof automatically provided). For instance, the implied query can be “patent news” based on profile data indicating interest in patents, the implied query periodically submitted, and a corresponding NL based summary result automatically rendered. It is noted that the provided NL based summary result can vary over time in view of e.g., presence of new/fresh search result document(s) over time.

Further, the client device 110, the NL based response system 120, and/or the search system 140 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form a coordinated ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household).

NL based response system 120 is illustrated as including a generative model (GM) selection engine 124, a GM input engine 126, a GM response generation engine 128, a fragment extraction engine 130, an entailment filtering engine 132, an entailment evaluation engine 134, a query formulation engine 136, and a rewriting engine 138. Some of the engines can be omitted and/or combined in various implementations.

The GM selection engine 124 can, for example, select zero or more generative models from multiple candidate generative models. For example, in some iterations the system will determine to not utilize any of the candidate generative models, in some iterations the system will determine to utilize only one of the candidate generative models, and in some iterations the system will determine to utilize multiple of the candidate generative models. GM selection engine 124 can optionally utilize one or more rules and/or one or more classifiers 125 that are trained to generate output identifying which generative models are best suited to generate a response to a current query, given a current user state/context.

The GM input engine 126 may be configured to assemble generative model input prompts based on data such as a current query, current user state/context, past queries, past generative outputs (which may be included in the current user state/context, etc. Generative model input prompts may, in some implementations, include a sequence of tokens, which may be words, phrases, or embeddings generated from data such as text, images, audio, etc.

The GM response generation engine 128 may be configured to apply one or more generative models stored in in a GM database 129 to input prompts generated by GM input engine 126 to generate generative model output. Generative model output may take various forms, such as a sequence of tokens that correspond to, represent, or directly convey words, phrases, embeddings, images, videos, audio, etc. Generative models stored in GM database 129 may take a variety of forms, including, but not limited to, model(s) such as PaLM, BERT, LaMDA, Meena, and/or any other generative model, such as any other generative model that is encoder-only based, decoder-only based, sequence-to-sequence based and that optionally includes an attention mechanism or other memory, diffusion model(s), etc. Generative models may have hundreds of millions, or even hundreds of billions of parameters. In some implementations, generative models may include multi-modal models such as a vision language model (VLM) and/or a visual question answering (VQA) model, which can have any of the aforementioned architectures, and which can be used to process multiple modalities of data, particularly images and text, and/or images and audio for example, to generate one or more modalities of output. Non-limiting examples of VLMs that may be applied as described herein include Gemini and/or Flamingo, to name a few.

Fragment extraction engine 130 may be configured to extract meaningful fragments of text (e.g., statements, complete sentences, independent clauses that stand on their own) from generative model output generated by GM response generation engine 128. For instance, in the generative model response “George Washington was the first President of the United States. He was born on Feb. 22, 1732, on his family's plantation on Papes Creek in Westmoreland County, Virginia,” the following fragments could be extracted: (i) “George Washington was the first President of the United States”; (ii) “He was born on Feb. 22, 1732”; and (iii) “He was born on his family's plantation on Papes Creek in Westmoreland County, Virginia.”

Entailment filtering engine 132 may be configured to evaluate the textual fragments extracted from generative model output by fragment extraction engine 130 using various criteria and/or techniques to determine which are suitable for textual entailment analysis (or put another way, “require attribution”). For example, phrases such as “Good afternoon” and “Thank you” are not suitable for textual entailment analysis because they do not state facts that can be corroborated or contradicted/refuted. By contrast, the statement “George Washington was the first President of the United States” is suitable for textual entailment analysis because it states at least one verifiable fact: that George Washington was the first US President.

Entailment filtering engine 132 may evaluate textual fragments extracted from generative model output for suitability for textual entailment analysis in various ways. In some implementations, entailment filtering engine 132 may use data sources such as a knowledge graph to identify entities and/or facts related to entities in textual fragments. If an entity and/or fact is identified based on a fragment, that fragment may be suitable for textual entailment analysis. If no entities or facts are identified, as would be the case for a statement such as “Good morning” or “thank you,” that fragment may not be suitable for textual entailment analysis, and may be discarded (or “filtered”) from consideration.

Additionally or alternatively, in some implementations, entailment filtering engine 132 may use one or more classifiers 133 that are trained to generate output indicative of whether input textual fragments are suitable for textual entailment analysis. Such a classifier may be trained, for instance, on a corpus of training data that includes textual fragments labeled as suitable or not suitable for textual entailment analysis. Classifier(s) 133 may take various forms, including machine learning models such as recurrent neural networks (RNNs), long short-term memory (LSTM) networks, gated recurrent unit (GRU) networks, transformers (e.g., with self-attention), or various type of generative models mentioned previously, including “scaled down” generative models that have less parameters than generative models used, e.g., by GM response generation engine 128. For example, an LLM used by GM response engine 128, which may include billions of parameters, may be used as a “teacher” model to train a “student” model (e.g., another LLM) with considerably fewer parameters to perform entailment filtering.

Entailment evaluation engine 134 may be configured to evaluate textual fragments that were classified as suitable for textual entailment analysis by entailment filtering engine 132 based on documents retrieved using those fragments. For instance, entailment evaluation engine 134 or another component, such as query formulation engine 136, may formulate, for each textual fragment that remains after entailment filtering engine 132 has filtered out unsuitable textual fragments, a search query that seeks documents or other content that can be used to corroborate or refute the textual fragment. In some implementations, query formulation engine 136 may leverage one or more machine learning models, such as one or more generative models 129 or separate model(s) (e.g., LLMs, recurrent neural networks, etc.), to formulate these search queries. Entailment evaluation engine 134 may then process the textual fragments and responsive documents/content using one or more entailment models 135.

For example, in some implementations, entailment evaluation engine 134 may assemble input prompts for both a corroboration entailment model 135A and a contradiction entailment model 135B. Each input prompt may include content extracted or otherwise derived from one or more responsive documents returned by search system(s) 140 based on one or more search queries formulated by query formulation engine 136. Models 135A-B may generate two different outputs, one output that is indicative of whether the responsive content corroborates (or “entails”) the textual fragment, and another output that is indicative of whether the responsive content contradicts the textual fragment. In other implementations, entailment evaluation engine 134 may use a single entailment model that generates an output such as a corroboration score and/or a classification of “corroborates” or “contradicts.” Whichever the case, based on these output(s), entailment evaluation engine 134 may generate various predictions of whether the at least one document corroborates or contradicts the textual fragment.

Rewriting engine 138 may be configured to use the predictions made by entailment evaluation engine 134 to determine how to render generative model output (e.g., generative model output generated using GM response generation engine 128) at client device 110, including whether aspects of the generative model output are to be rewritten (either before, or shortly after rendering the generative model output at the client device 110, in order to refrain from rendering potentially false information and/or hallucinations, and/or can quickly and efficiently remove any potentially false information and/or hallucinations that are being rendered from display). Specifically, the rewriting engine 138 may be configured to determine, based on a prediction that a first textual fragment of the generative model output is contradicted, that at least a portion of the generative model output comprising that first textual fragment should be rewritten.

Further, the rewriting engine 138 may be configured to cause generation of revised generative model output, which can be generated using any or all of the GM selection engine 124, classifier(s) 125, GM input engine 126, GM response generation engine 128, and generative model(s) 129 in a manner generally corresponding to the (original) generative model output. Generative model output may generally be rendered at the client device 110 (e.g., by rendering engine 112) in a real-time manner, e.g., the generative model output may be generated as a series of segments (e.g., words, phrases, fragments, statements, facts, clauses, images, videos, audio, etc.), one after another, and responsively rendered one after another in a real-time manner. The rewriting engine 138 can cause the client device 110 to refrain from rendering the portion of the generative model output including the first textual fragment and/or can cause the client device 110 to ‘roll back’ (i.e., remove from display) the portion of the generative model output including the first textual fragment, and can cause the revised generative model output to be rendered for display instead (and optionally can cause a UI affordance explaining the rewriting to be rendered for display as well).

Search system 140 is illustrated as including a search result document (SRD) engine 142 and a results engine 144. Some of the engines can be omitted or combined with each other in various implementations. The SRD engine 142 can, for example, utilize indices 143 and/or other resources in identifying search result documents that are responsive to queries as described herein. For example, SRD engine 142 can use queries formulated by component(s) of NL based response system 120, such as query formulation engine 136, to identify search result documents or other content that potentially corroborates and/or contradicts textual fragments. The results engine 144 can generate search results that can optionally be presented along with an NL based summary described herein, and/or that may be used by GM response generation engine 128 to generate generative model responses.

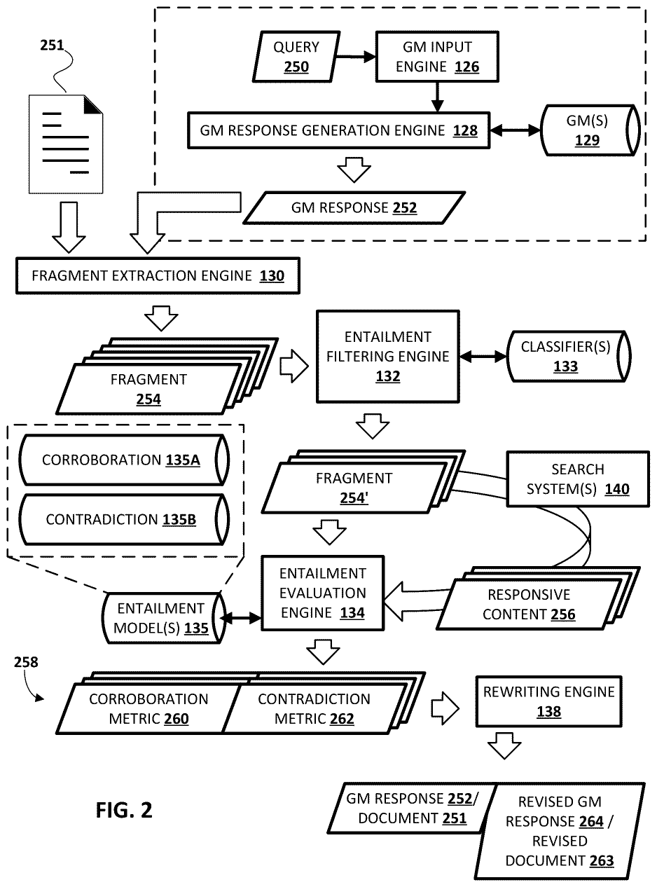

FIG. 2 schematically depicts an example of how various components depicted in FIG. 1 may cooperate to carry out selected aspects of the present disclosure. Starting at the top right in the dashed rectangle, a NL based query 250 may be received, e.g., at user input engine 111 of client device 110. NL based query 250 may be typed, may be transcribed using ASR on a spoken utterance, or may even be an implied query. Whichever the case, data indicative of NL based query 250 may be processed by GM response generation engine 128 using one or more generative models from database 129 to generate a GM response 252.

While not all shown in FIG. 2 for purposes of brevity and simplicity, it should be understood that in various implementations, other components upstream of GM response generation engine 128, such as one or more of engines 124-126, may perform various operations to prepare the input prompt that is ultimately processed by GM response generation engine 128 using generative model(s) such as LLM(s) to generate GM response 252. GM response 252 may include, for instance, one or more sentences, paragraphs, images, audio, video, etc., that are responsive to NL based query 250. It should also be understood that techniques described herein that are represented outside of the dashed box at the top in FIG. 2 may be used to perform entailment analysis of content other than generative model response 252. For example, and as shown at top left in FIG. 2, any other type of document 251 (e.g., web page, social media post, video or transcript thereof, etc.) may be processed by fragment extraction engine 130 and the other components depicted downstream in FIG. 2 to perform entailment analysis on that document 251.

GM response 252 (or document 251 as the case may be) may be processed by fragment extraction engine 130 to extract some number of content fragments 254 (e.g., sentences, clauses, expressions, phrases, claims, images or portions thereof, audio or portions thereof, videos or portions thereof, etc.) that can be independently processed by downstream components. In various implementations, fragment extraction engine 130 may employ rules-based or machine learning-based approaches to extract fragments 254. In the former case, fragment extraction engine 130 may extract individual sentences, clauses of sentences separated by punctuation, etc. Alternatively, fragment extraction engine 130 may use a machine learning model, such as a deep neural network, to extract fragments 254. For example, the machine learning model may be trained to process data indicative of GM response 252 (or document 251) and output data indicative of predicted barriers between textual fragments of the GM response 252 (or document 251).

However fragments 254 are extracted, entailment filtering engine 132 may be configured to classify a subset 254′ of the fragments 254 as being suitable for textual entailment analysis. For example, entailment filtering engine 132 may employ one or more trained classifiers 133 to classify individual fragments of content as being suitable or not suitable for textual entailment analysis, or in case of regression, to predict suitability scores for textual entailment analysis. As noted previously, classifier(s) 133 may take various forms, such as transformer-based generative models (e.g., LLMs), RNNs, LSTM networks, GRU networks, or other types of encoder-decoder, encoder only, or decoder only models. In other implementations, entailment filtering engine 132 may use rules based approaches to filter out content fragments that are not suitable for textual entailment analysis. For example, entailment filtering engine 132 may leverage a knowledge graph or other database to identify entities and/or facts in content fragments, which in turn may suggest suitability for textual entailment analysis.

The subset 254′ of textual fragments deemed suitable for textual entailment analysis may be provided to both search system(s) 140 and entailment evaluation engine 134. Search system(s) 140 may use the subset of textual fragments to formulate some number of search queries (not depicted in FIG. 2). These search queries may be used by engine 142 and/or 144 of search system(s) 140 to retrieve responsive content 256. Responsive content 256 may include documents (e.g., text-based, images, audio, etc.), snippets/portions of documents that are most directly responsive to a search query, or other content that is derived from responsive documents (e.g., using LLMs, VLMs, etc.). Responsive content 256 can be paired as applicable with the textual fragments of the subset 254′.

In some implementations, SRD engine 142 and/or results engine 144 may be configured to evaluate the quality, credibility, and/or reliability of search result document(s) (or more generally, responsive content 256), and provide one or more responsive content quality metrics to other components described herein, such as components of NL based response system 120. These responsive content quality metrics may be determined in various ways. In some implementations, the responsive content quality metrics may include query-dependent metrics, which are metrics that account for both the search query and the responsive content together. Additionally or alternatively, in some implementations, these responsive content quality metrics may include query-independent metrics, which may include metrics that are determined, e.g., by search system 140, independently of any queries.

In various implementations, these responsive content quality metric(s) may be used, e.g., by entailment filtering engine 132 and/or entailment evaluation engine 134, as a threshold for determining whether to proceed with textual entailment analysis. For example, while a particular textual fragment may be deemed suitable for textual entailment analysis by entailment filtering engine 132, entailment evaluation engine 134 may determine that responsive content 256 that is retrieved based on the particular textual fragment is not of sufficient quality to be considered as corroborating or contradicting the textual fragment. For example, the website from which responsive content 256 was obtained may be deemed to lack credibility. In some such instances, entailment evaluation engine 134 and/or rewriting engine 138 may refrain from rewriting the textual fragment in the GM response 252 (or document 251). In other such instances, entailment evaluation engine 134 and/or rewriting engine 138 may cause client device 110 to render output that indicates potentially weakly corroborating or contradicting evidence for that textual fragment.

Entailment evaluation engine 134 may process pairs of textual fragments 254′ and corresponding responsive content 256 (whole documents or fragments/snippets extracted therefrom) using one or more entailment models 135 to generate predictions 258 of whether responsive content 256 corroborate or contradict corresponding textual fragments. In FIG. 2, for instance, entailment evaluation engine 134 processes the pairs of textual fragments 254′ and corresponding responsive content 256 using a corroboration model 135A and a contradiction model 135B. Consequently, predictions 258 include both corroboration metrics 260 and contradiction metrics 262.

In some implementations, models 135A, 135A may be applied to copies of the pairs in parallel (e.g., as separate threads) to speed up processing and/or reduce latency. Additionally or alternatively, in some implementations, entailment evaluation engine 134 may process multiple different pairs of textual fragments 254′ and corresponding responsive content 256 in parallel to further reduce latency.

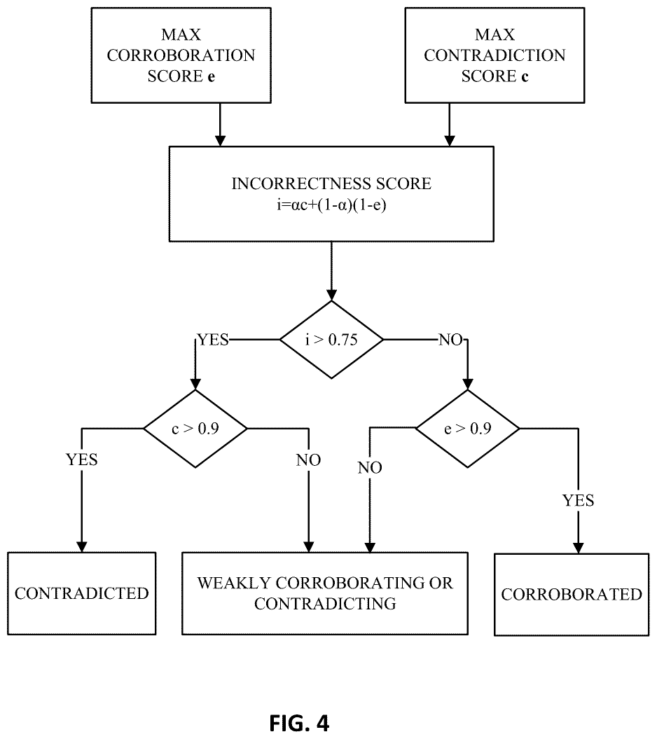

In various implementations, corroboration metrics 260 and contradiction metrics 262 may be evaluated, e.g., by entailment evaluation engine 134 and/or another component, such as rewriting component 138, to determine how to cause visual or audio output to be rendered at client device 110. In FIG. 2, for instance, rewriting engine 138 uses corroboration metrics 260 and contradiction metrics 262 to determine whether any portions of the GM response 252/document 251 are to be rewritten, e.g., as GM response 252/document 251 is being initially rendered by rendering engine 112 of client device 110 or after GM response 252/document 251 have been rendered. One non-limiting example of rules and/or heuristics that may be used by rewriting engine 138 or another component is demonstrated in FIG. 4. In some implementations, rewriting engine 138 may decide whether any portions of the GM response 252/document 251 are to be rewritten based on a comparison (e.g., as depicted in FIG. 4) of the corroboration metric 260 with the contradiction metric 262.

For example, the rewriting engine 138 may determine, based on the corroboration metric 260 and/or the contradiction metric 262 for a first textual fragment included in the GM response 252 that the first textual fragment is contradicted, and that at least the portion of the GM response 252 including that first textual fragment should be rewritten. Further, the rewriting engine 138 may be configured to cause generation of revised GM response 264 (or revised document 263 as it might be), which can be generated in a manner generally corresponding to the (original) GM response (e.g., using any or all of the components shown in the dashed box at the top in FIG. 2). The rewriting engine 138 can cause the client device 110 to refrain from rendering the portion of the GM response 252 including the first textual fragment and/or can cause the client device 110 to ‘roll back’ (i.e., remove from display) the portion of the GM response 252 including the first textual fragment, and can cause the revised GM response 264 to be rendered for display instead (and optionally can cause a UI affordance explaining the rewriting to be rendered for display as well).

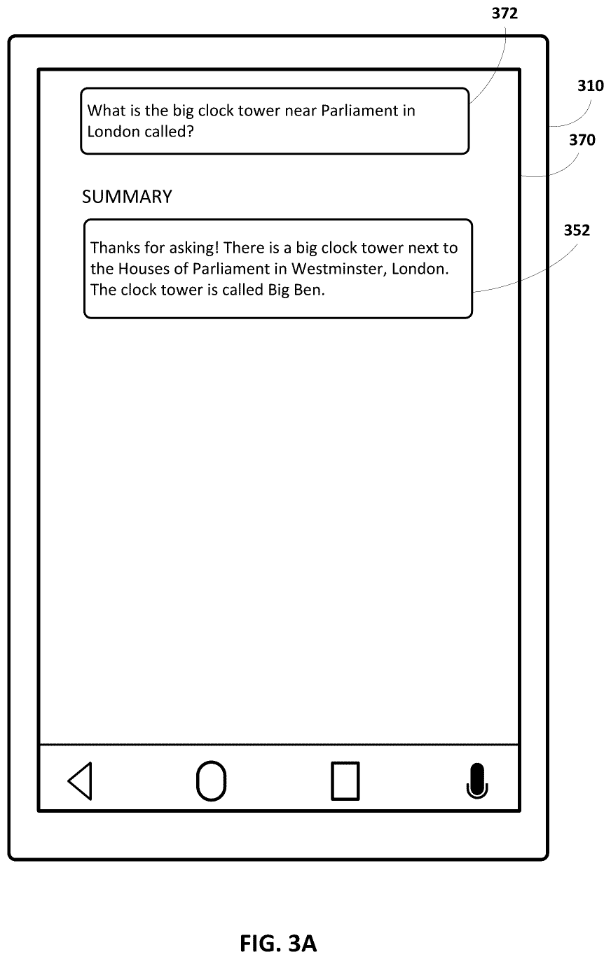

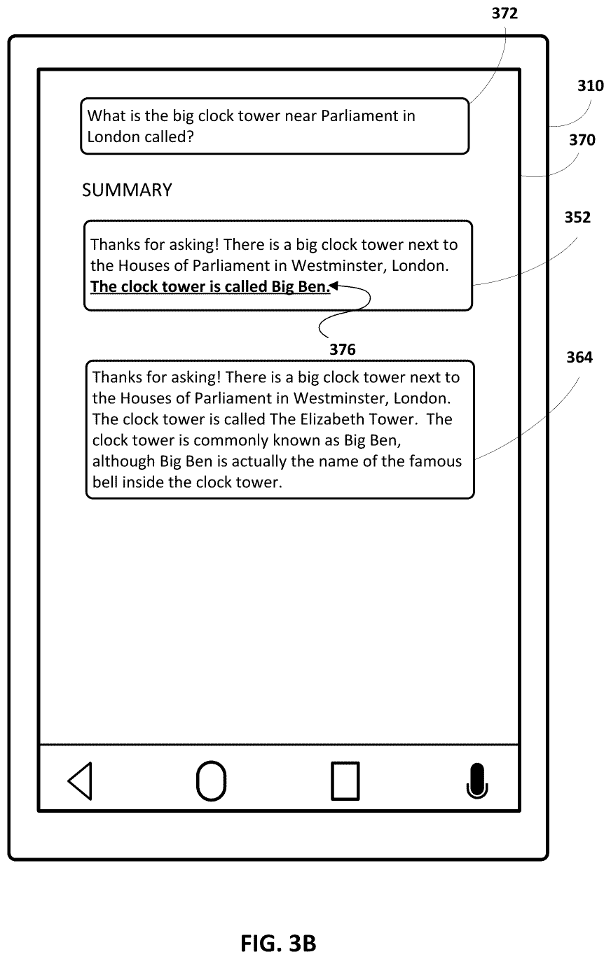

FIG. 3A depicts an example client device 310 in the form of a tablet computer that is being used to engage with NL based response system 120. Client device 310 includes a display 370 on which a query input field 372 is rendered. A user (not depicted) has entered, into query input field 372 (by typing or having a spoken utterance speech recognized), the query, “What is the big clock tower near Parliament in London called?”. A GM response 352 that may share various characteristics with GM response 252 in FIG. 2 is generated by GM response generation engine 128 and rendered on display 370. Specifically, the GM response 352 reads “Thanks for asking! There is a big clock tower next to the Houses of Parliament in Westminster, London. The clock tower is called Big Ben”. The process depicted in FIG. 2 involving textual entailment analysis of this GM response may automatically be performed.

In FIG. 3B, textual fragment 376 of GM response 352 is highlighted, i.e., “The clock tower is called Big Ben”. In this specific example, the aspect of GM response 352 reading “Thanks for asking!” may be a separate textual fragment, and “There is a big clock tower next to the Houses of Parliament in Westminster, London” may also be a separate textual fragment. However, textual fragment 376 is discussed herein because the processing of FIG. 2 revealed that there is a source of data that tends to contradict this statement. Specifically, one or more sources of data indicate that the clock tower is actually called the “Elizabeth Tower”, and not “Big Ben”.

As such, the techniques described herein can be used to recognize that at least the aspect of GM response 352 which states that the clock tower is called “Big Ben” should be rewritten. It will be appreciated that the rewriting can take a variety of different forms. For example, the client device 310 may ‘roll back’ the response all the way to the beginning, or to the end of the textual fragment “Thanks for asking!” (which would not be subject to a textual entailment analysis, as described herein). As another example, the client device 310 may ‘roll back’ just the sentence containing the particular textual fragment which is contradicted, i.e., rolling back to the end of the textual fragment “There is a big clock tower next to the Houses of Parliament in Westminster, London”.

A revised GM response can be generated based on e.g., the original query, the contradicted textual fragment, the currently rendered portions of the GM response (which in this example, may be corroborated aspects of the GM response up to the end of the textual fragment “There is a big clock tower next to the Houses of Parliament in Westminster, London”), and optionally the source of data which indicates that the clock tower is actually called the “Elizabeth Tower”, and not “Big Ben”. In other words, a revised GM response can be generated which continues the currently rendered portions of the GM response whilst being specifically instructed to correct the error with the contradicted textual fragment.

In this example, a revised GM response 364 of “Thanks for asking! There is a big clock tower next to the Houses of Parliament in Westminster, London. The clock tower is called The Elizabeth Tower. The clock tower is commonly known as Big Ben, although Big Ben is actually the name of the famous bell inside the clock tower.” is shown in FIG. 3B. The revised GM response 364 may share various characteristics with revised GM response 264 in FIG. 2, and may be generated by GM response generation engine 128 and rendered on display 370. Although revised GM response 364 is shown separate from GM response 352 in FIG. 3B, it is understood that in various implementations the GM response 352 and the revised GM response 364 may not be rendered simultaneously and/or separately. For example, in various implementations a portion of the GM response 352 can be ‘rolled back’ (e.g., “called Big Ben” or “The clock tower is called Big Ben.”) and replaced with a revised portion such as “The clock tower is called The Elizabeth Tower. The clock tower is commonly known as Big Ben, although Big Ben is actually the name of the famous bell inside the clock tower.” Specifically (and consistent with the manner in which generative model output/GM responses can be rendered in segments as described herein), the GM response 352 may be rendered first, then at least a portion of the GM response 352 including the textual fragment 376 may be rolled back and/or removed, and then subsequently the revised GM response 364 (which may build from/overlap with at least part of the GM response 352) may be rendered, for example. Put another way, in various implementations “Thanks for asking! There is a big clock tower next to the Houses of Parliament in Westminster, London.” In GM response 352 can remain and “The clock tower is called Big Ben.” removed from the GM response 152 and replaced with “The clock tower is called The Elizabeth Tower. The clock tower is commonly known as Big Ben, although Big Ben is actually the name of the famous bell inside the clock tower.” This can be done without a separate simultaneous rendering of “Thanks for asking! There is a big clock tower next to the Houses of Parliament in Westminster, London.”

Further, although not shown in FIG. 3B, a window including revised GM response 364 could also display snippet(s)/fragment(s) from the source of data that tend to contradict textual fragment 376 (i.e., in order to provide evidence for the rewritten version of the GM response). Additionally, although not shown in FIG. 3B, a window including revised GM response 364 could also display a UI affordance which explains that the portion of the generative model output including the textual fragment 376 has been removed from display and rewritten (and optionally referring to the contracting source of data).

FIG. 4 schematically depicts an example of logic that may be implemented, e.g., by rendering engine 138, to determine whether a portion of the generative model output is to be rewritten based on corroboration metrics 260 and contradiction metrics 262. Starting at the top, for a given textual fragment (254′ in FIG. 2) and corresponding responsive content (256 in FIG. 2), a maximum corroboration score e may be generated, e.g., by entailment evaluation engine 134 using corroboration model 135A. Likewise, a maximum contradiction score c may be generated, e.g., by entailment evaluation engine 134 using contradiction model 135B.

A general “incorrectness” score i may then be calculated. In some implementations, the incorrectness score is a weighted average between the maximum contradiction score c and the maximum corroboration score e (or in some cases, 1-e). Taking a weighted average may account for the situation in which no documents or other responsive content is found that strongly contradicts or corroborates the fragments. In some implementations, the following formula may be used, with α being a weight determined from empirical evidence:

$$i = α c + ( 1 - α ) ( 1 - e ) \qquad ( 1 )$$

If i is greater than a first threshold, say, 0.75, then c may be compared to a second threshold, say, 0.9. If c is greater than the second threshold, then the given textual fragment may be considered contradicted by the responsive content. As a result, rendering engine 138 may determine that the portion of the generative model output including that given textual fragment is to be rewritten. However, if c is less than the second threshold, then a determination may be made that the given textual fragment may only be considered weakly contradicted by the responsive content (but e.g., the potential contradiction is not conclusive enough to warrant rewriting of the portion of the generative model output including that given textual fragment). For example, this weak contradiction could be annotated or highlighted to the user as part of the generative model output (e.g., through the color which is used to display the given textual fragment in the generative model output).

Going back to equation (1), if i is less than the first threshold (e.g., 0.75), then e may be compared to a third threshold, say, 0.9 (which may or may not be the same as the second threshold). If e is greater than the third threshold, then the given textual fragment may be considered corroborated. As a result, rendering engine 138 may determine that the portion of the generative model output including that given textual fragment does not need to be rewritten. However, if e is less than the third threshold, then a determination may be made that the given textual fragment may only be considered weakly corroborated by the responsive content. For example, this weak corroboration could be annotated or highlighted to the user as part of the generative model output (e.g., through the color which is used to display the given textual fragment in the generative model output). The thresholds depicted in FIG. 4 are for demonstration purposes only, and are not meant to be limiting.

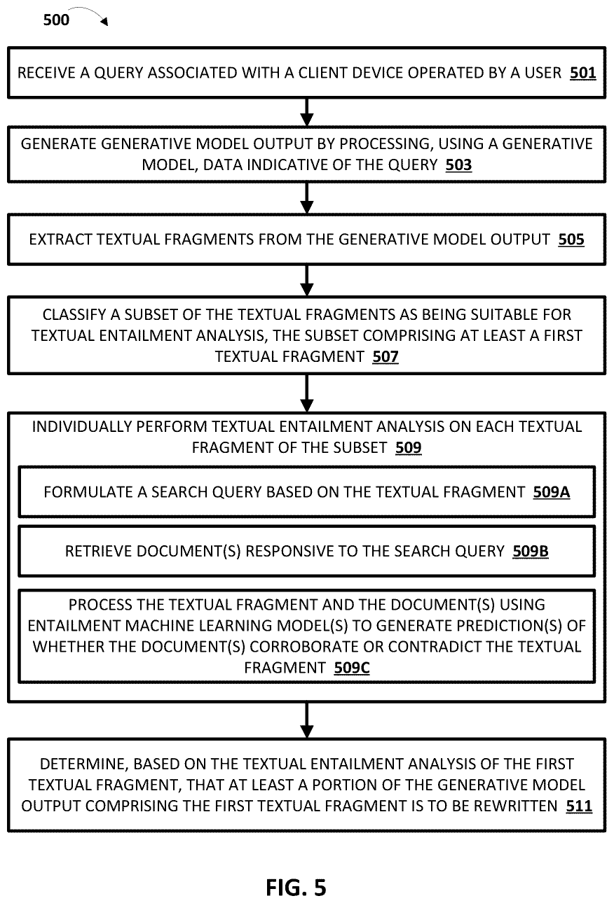

Turning now to FIG. 5, a flowchart is depicted that illustrates an example method 500 of implementing selected aspects of the present disclosure. For convenience, the operations of the method 500 are described with reference to a system that performs the operations. This system of the method 500 includes one or more processors, memory, and/or other component(s) of computing device(s) (e.g., client device 110 of FIG. 1, one or more servers, and/or other computing devices). Moreover, while operations of the method 500 are shown in a particular order, this is not meant to be limiting. One or more operations may be reordered, omitted, and/or added.

At block 501, the system, e.g., by way of user input engine 111 of client device 110, may receive a query associated with a client device operated by the user. For example, user input engine 111 may capture and transcribe a spoken utterance into a textual query, and then provide that textual query to NL based response system 120. Alternatively, the user may type a textual query.

At block 503, the system, e.g., by way of GM response generation engine 128, may generate generative model output (e.g., 252) based on processing data indicative of the query using a generative model from database 129. Data indicative of the query may include, for instance, a sequence of tokens that includes words, phrases, and/or characters of the query, or embeddings generated therefrom.

At block 505, the system, e.g., by way of fragment extraction engine 130, may extract a plurality of fragments (textual or otherwise) from the generative model output. At block 507, the system, e.g., by way of entailment filtering engine 132, may classify a subset (e.g., 254′) of the fragments as being suitable for textual entailment analysis, e.g., using one or more classifier models from database 133. The subset 254′ may include at least a first textual fragment (e.g., a textual fragment which may later be identified as requiring correction), and may optionally further comprise textual fragment(s) (e.g., second, third, etc., textual fragment(s) which may later be identified as corroborated and as not requiring correction).

At block 509, the system, e.g., by way of entailment evaluation engine 134, may individually perform textual entailment analysis on each textual fragment of the subset. In various implementations, the textual entailment analysis may include, for each textual fragment of the subset, performing operations associated with blocks 509A-C. At block 509A, for instance, the system may formulate a search query based on the textual fragment of the subset currently under consideration. For instance, words and/or phrases of the fragment of the subset may be used to formulate a search query.

At block 509B, the system may retrieve at least one document or portion thereof (or more generally, content) that is responsive to the search query. At block 509C, the system may process the textual fragment under consideration and the at least one document retrieved at block 509B using one or more entailment machine learning models 135 to generate one or more predictions of whether the at least one document corroborates or contradicts the textual fragment. For example, as illustrated in FIG. 2, the textual fragment and responsive content may be processed using both a corroboration model 135A and a contradiction model 135B, e.g., in parallel, to generate corroboration metric 260 and contradiction metric 262, respectively.

At block 511, the system, e.g., by way of rewriting engine 138, may determine, based on the textual entailment analysis of the first textual fragment, that at least a portion of the generative model output comprising the first textual fragment is to be rewritten. In some implementations, the generative model output may be rendered initially, and then may be updated (e.g., based on revised generative model output) after techniques described herein have had time to complete (e.g., identifying that the first textual fragment is contradicted, generative the revised generative model output, etc.). For example, the generative model output may be replaced with the revised generative model output in some scenarios. In other scenarios, the generative model output may ‘roll back’ (or refrain from rendering in the first place) at least a portion of the generative model output including the first textual fragment. The content for rendering to a user can be ‘completed’ by generating revised generative model output, which may, for example, take into account aspects of the generative model output which are currently rendered (and e.g., which have been identified as including corroborated textual fragments).

While examples described herein have related primarily to performing entailment analysis on generative model output, this is not meant to be limiting. In various implementations, techniques described herein may be used to perform entailment analysis on any type of document. For example, web pages can be created by anyone without any oversight, and as a consequence, inaccurate information is propagated across the Internet. Techniques described herein may be used to perform entailment analysis on web pages and/or on any other type of document, such as textual documents, videos (e.g., with transcripts that can be evaluated), and so forth. In some such cases, the operations of method 500 may be performed beginning at block 505, with the document under consideration replacing the generative model output.

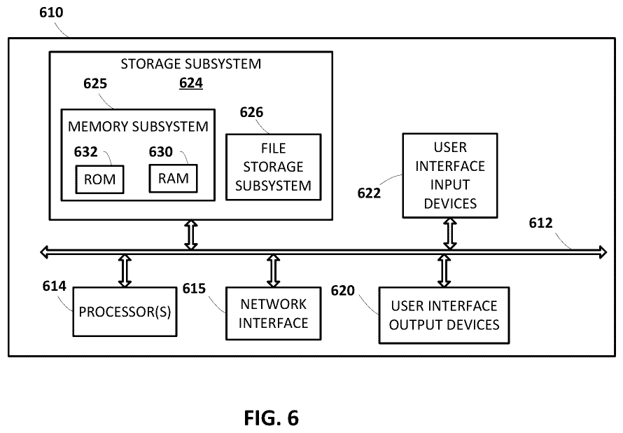

Turning now to FIG. 6, a block diagram of an example computing device 610 that may optionally be utilized to perform one or more aspects of techniques described herein is depicted. In some implementations, one or more of a client device, cloud-based automated assistant component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIG. 1 or 2.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614. Bus subsystem 612 provides a mechanism for letting the various components and subsystems of computing device 610 communicate with each other as intended. Although bus subsystem 612 is shown schematically as a single bus, alternative implementations of the bus subsystem 612 may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In situations in which the systems described herein collect or otherwise monitor personal information about users, or may make use of personal and/or monitored information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be altered before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that the user's particular geographic location cannot be determined. Thus, the user may have control over how information is collected about the user and/or used.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In some implementations, a method implemented by one or more processors is provided, and includes: receiving a query associated with a client device operated by a user; generating generative model output by processing, using a generative model, data indicative of the query; extracting a plurality of textual fragments from the generative model output; classifying a subset of the textual fragments as being suitable for textual entailment analysis, the subset including at least a first textual fragment; individually performing textual entailment analysis on each textual fragment of the subset; and determining, based on the textual entailment analysis of the first textual fragment, that at least a portion of the generative model output comprising the first textual fragment is to be rewritten. Textual entailment analysis includes, for each textual fragment of the subset: formulating a search query based on the textual fragment, retrieving at least one document that is responsive to the search query, and processing the textual fragment and the at least one document using one or more entailment machine learning models to generate one or more predictions of whether the at least one document corroborates or contradicts the textual fragment.

These and other implementations of technology disclosed herein can optionally include one or more of the following features.

In some implementations, for the first textual fragment, the one or more predictions can satisfy a threshold indicative of the at least one document contradicting the first textual fragment.

In some implementations, the method can further include: receiving, in one or more segments, the generative model output; and for each of the one or more segments: in response to receiving the segment, causing the segment of the generative model output to be rendered for display at the client device.

In some implementations, the method can further include: in response to determining that at least the portion of the generative model output including the first textual fragment is to be rewritten, generating revised generative model output based on processing, using the generative model, data indicative of the query, data indicative of a portion of the generative model output currently rendered for display at the client device, and data indicative of the first textual fragment.

In some versions of those implementations, generating the revised generative model output can further be based on processing, using the generative model, the at least one document retrieved responsive to the search query formulated for the first textual fragment.

In additional or alternative versions of those implementations, the portion of the generative model output currently rendered for display at the client device does not include the portion of the generative model output including the first textual fragment, and the method can further include: in response to determining that at least the portion of the generative model output including the first textual fragment is to be rewritten: causing the client device to refrain from rendering at least the portion of the generative model output including the first textual fragment for display; and causing the revised generative model output to be rendered for display at the client device.

In additional or alternative versions of those implementations, the portion of the generative model output currently rendered for display at the client device includes the portion of the generative model output including the first textual fragment, and the method can further include: in response to determining that at least the portion of the generative model output including the first textual fragment is to be rewritten: causing the client device to remove at least the portion of the generative model output including the first textual fragment from display; and causing the revised generative model output to be rendered for display at the client device.

In some versions of those implementations, the method can further include: causing a user interface (UI) affordance to be rendered for display at the client device, the UI affordance indicating that at least the portion of the generative model output including the first textual fragment has been removed from display and rewritten.

In some versions of those implementations, the UI affordance can provide an indication of the at least one document retrieved responsive to the search query formulated for the first textual fragment.

In some implementations, the one or more entailment machine learning models can include: a corroboration machine learning model trained to generate first output indicative of whether a document corroborates a textual fragment; and/or a contradiction machine learning model trained to generate second output indicative of whether a document contradicts a textual fragment.

In some versions of those implementations, for each textual fragment of the subset, the one or more of the predictions can be determined based on a comparison of the first and second outputs.

In some implementations, each textual fragment of the subset can be classified as suitable for textual entailment analysis based on an entailment score predicted for the textual fragment using a regression machine learning model that is trained to predict textual entailment analysis suitability scores for textual fragments.

In some implementations, the subset of the textual fragments can include a plurality of textual fragments, and the textual entailment analysis can be performed for the plurality of textual fragments in parallel.

In addition, some implementations include one or more processors (e.g., central processing unit(s) (CPU(s)), graphics processing unit(s) (GPU(s)), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more computer-readable storage media (e.g., transitory and/or non-transitory) storing computer instructions executable by one or more processors to perform any of the aforementioned methods. Some implementations also include a computer program product including instructions executable by one or more processors to perform any of the aforementioned methods.

What is claimed is:

1. A method implemented by one or more processors, the method comprising:
receiving a query associated with a client device operated by a user;
generating generative model output by processing, using a generative model, data indicative of the query;
extracting a plurality of textual fragments from the generative model output;
classifying a subset of the textual fragments as being suitable for textual entailment analysis, the subset comprising at least a first textual fragment;
individually performing textual entailment analysis on each textual fragment of the subset, wherein the textual entailment analysis includes, for each textual fragment of the subset:
formulating a search query based on the textual fragment,
retrieving at least one document that is responsive to the search query, and
processing the textual fragment and the at least one document using one or more entailment machine learning models to generate one or more predictions of whether the at least one document corroborates or contradicts the textual fragment; and
determining, based on the textual entailment analysis of the first textual fragment, that at least a portion of the generative model output comprising the first textual fragment is to be rewritten.

2. The method of claim 1, wherein, for the first textual fragment, the one or more predictions satisfy a threshold indicative of the at least one document contradicting the first textual fragment.

3. The method of claim 1, further comprising:
receiving, in one or more segments, the generative model output; and
for each of the one or more segments:
in response to receiving the segment, causing the segment of the generative model output to be rendered for display at the client device.

4. The method of claim 1 further comprising:
in response to determining that at least the portion of the generative model output comprising the first textual fragment is to be rewritten, generating revised generative model output based on processing, using the generative model, data indicative of the query, data indicative of a portion of the generative model output currently rendered for display at the client device, and data indicative of the first textual fragment.

5. The method of claim 4, wherein generating the revised generative model output is further based on processing, using the generative model, the at least one document retrieved responsive to the search query formulated for the first textual fragment.

6. The method of claim 4, wherein the portion of the generative model output currently rendered for display at the client device does not comprise the portion of the generative model output comprising the first textual fragment, the method further comprising:
in response to determining that at least the portion of the generative model output comprising the first textual fragment is to be rewritten:
causing the client device to refrain from rendering at least the portion of the generative model output comprising the first textual fragment for display; and
causing the revised generative model output to be rendered for display at the client device.

7. The method of claim 4, wherein the portion of the generative model output currently rendered for display at the client device comprises the portion of the generative model output comprising the first textual fragment, the method further comprising:
in response to determining that at least the portion of the generative model output comprising the first textual fragment is to be rewritten:
causing the client device to remove at least the portion of the generative model output comprising the first textual fragment from display; and
causing the revised generative model output to be rendered for display at the client device.

8. The method of claim 7, further comprising:
causing a user interface (UI) affordance to be rendered for display at the client device, the UI affordance indicating that at least the portion of the generative model output comprising the first textual fragment has been removed from display and rewritten.

9. The method of claim 8, wherein the UI affordance provides an indication of the at least one document retrieved responsive to the search query formulated for the first textual fragment.

10. The method of claim 1, wherein the one or more entailment machine learning models comprise:
a corroboration machine learning model trained to generate first output indicative of whether a document corroborates a textual fragment; and/or
a contradiction machine learning model trained to generate second output indicative of whether a document contradicts a textual fragment.

11. The method of claim 10, wherein, for each textual fragment of the subset, the one or more of the predictions are determined based on a comparison of the first and second outputs.

12. The method of claim 1, wherein each textual fragment of the subset is classified as suitable for textual entailment analysis based on an entailment score predicted for the textual fragment using a regression machine learning model that is trained to predict textual entailment analysis suitability scores for textual fragments.

13. The method of claim 1, wherein the subset of the textual fragments includes a plurality of textual fragments, and wherein the textual entailment analysis is performed for the plurality of textual fragments in parallel.

14. The method of claim 1, wherein the one or more entailment machine learning models comprise both:
a corroboration machine learning model trained to generate first output indicative of whether a document corroborates a textual fragment; and
a contradiction machine learning model trained to generate second output indicative of whether a document contradicts a textual fragment.

15. A system comprising:
memory storing instructions; and
one or more processors operable to execute the instructions to:
receive a query associated with a client device;
cause generative model output to be generated based on processing, using a generative model, of data indicative of the query;
extract a plurality of textual fragments from the generative model output;
classify a subset of the textual fragments as being suitable for textual entailment analysis, the subset comprising at least a first textual fragment;
individually perform textual entailment analysis on each textual fragment of the subset, wherein in performing the textual entailment analysis one or more of the processors are to, for each textual fragment of the subset:
formulate a search query based on the textual fragment,
retrieve at least one document that is responsive to the search query, and
process the textual fragment and the at least one document using one or more entailment machine learning models to generate one or more predictions of whether the at least one document corroborates or contradicts the textual fragment; and
determine, based on the textual entailment analysis of the first textual fragment, that at least a portion of the generative model output comprising the first textual fragment is to be rewritten.

16. The system of claim 15, wherein, for the first textual fragment, the one or more predictions satisfy a threshold indicative of the at least one document contradicting the first textual fragment.

17. The system of claim 15, wherein one or more of the processors are further operable to execute the instructions to:
receive, in one or more segments, the generative model output; and
for each of the one or more segments:
in response to receiving the segment, cause the segment of the generative model output to be rendered for display at the client device.

18. The system of claim 15, wherein one or more of the processors are further operable to execute the instructions to:
in response to determining that at least the portion of the generative model output comprising the first textual fragment is to be rewritten, cause revised generative model output to be generated based on processing, using the generative model, data indicative of the query, data indicative of a portion of the generative model output currently rendered for display at the client device, and data indicative of the first textual fragment.

19. The system of claim 18, wherein generating the revised generative model output is further based on processing, using the generative model, the at least one document retrieved responsive to the search query formulated for the first textual fragment.
